(19) United States
(12) Patent Application Publication
(10) Pub. No.: US 2006/0171660 A1
(43) Pub. Date: Aug. 3, 2006

(54) Hand dryer equipped with video and audio playing functions

(75) Inventor: Chi-Chin Hsu, Taipei County (TW)

Correspondence Address: BIRCH STEWART KOLASCH & BIRCH, PO BOX 747, FALLS CHURCH, VA, 22040-0747, US

(73) Assignee: Hokwang Industries Co., Ltd.

(21) Appl. No.: 11/047,721

(22) Filed: Feb. 2, 2005

(51) Int. Cl. H04N 5/91

(52) U.S. Cl. 386/46

(57) ABSTRACT

A hand dryer equipped with video and audio playing functions aims to provide the basic hand drying function and to include a video and audio displaying device so that when users use the hand dryer or pass by the hand dryer, the video and audio displaying device broadcasts dynamic video and audio data, thereby to meet the modern multimedia requirements and enhance the added value of the hand dryer.

### FIELD OF THE INVENTION

The present invention relates to a hand dryer and particularly to a hand dryer equipped with video and audio playing functions.

### BACKGROUND OF THE INVENTION

Hand dryers are widely used in hotels, restaurants, shopping malls or the like to enable users to dry hands after washing without paper or towels in the event that the users do not bring paper tissues or a handkerchief with them.

Besides providing the basic function of hand drying, some hand dryers also provide additional functions. For instance, R.O.C. Patent Publication No. M247158 discloses a “Hand dryer equipped with a displaying device”. It mainly includes a displaying device which is connected to a control circuit inside the hand dryer. Through the control circuit the displaying device can display preset pictures or texts, such as logos of vendors, trademarks, merchandise advertisements, promotional messages, or the like.

However, the aforesaid hand dryer equipped with the displaying device can provide only “static” pictures or texts. It is plain and unexciting, and does not have much appeal to users these days when multimedia video and audio articles flourish almost everywhere. In short, the conventional hand dryer equipped with a displaying device cannot provide “dynamic” video and audio functions. This becomes a big disadvantage.

### SUMMARY OF THE INVENTION

Therefore the object of the present invention is to provide a hand dryer equipped with video and audio playing functions so that besides providing the basic hand drying function, it also can broadcast dynamic video and audio data.

To achieve the foregoing object, the hand dryer equipped with video and audio playing functions according to the invention mainly includes a case, a blower, a control circuit board, a first sensor, a video and audio displaying device, and a second sensor. The case has an air outlet. The blower is located in the case corresponding to the air outlet. The control circuit board is located in the case and connected electrically to the blower. The first sensor is exposed outside the case through the air outlet and connected electrically to the control circuit board to provide a first signal to the control circuit board to actuate the blower. The video and audio displaying device is located in the case and has a display area exposed outside the case. The second sensor is exposed outside the case and connected electrically to the video and audio displaying device, and provides a second signal to the video and audio displaying device to broadcast dynamic video and audio data.

In short, the hand dryer equipped with video and audio playing functions according to the invention, in addition to providing the basic function of drying user's hands when the user moves close to the hand dryer, also can broadcast dynamic video and audio data while the user dries his/her hands or passes by the hand dryer. Thus it can meet varying video and audio requirements of the modern time.

The foregoing, as well as additional objects, features, and advantages of the invention will be more readily apparent from the following detailed description, which proceeds with reference to the accompanying drawings.

### BRIEF DESCRIPTION OF THE DRAWINGS

FIG. 1 is a fragmentary exploded view of a first embodiment of the hand dryer equipped with video and audio functions of the present invention.

FIG. 2 is a perspective view of the first embodiment of the hand dryer equipped with video and audio functions of the present invention.

FIG. 3 is an operation flow chart of the first embodiment of the hand dryer equipped with video and audio functions of the present invention.

FIG. 4 is a fragmentary exploded view of a second embodiment of the hand dryer equipped with video and audio functions of the present invention.

FIG. 5 is a perspective view of the second embodiment of the hand dryer equipped with video and audio functions of the present invention.

FIG. 6 is an operation flow chart of the second embodiment of the hand dryer equipped with video and audio functions of the present invention.

### DETAILED DESCRIPTION OF THE PREFERRED EMBODIMENTS

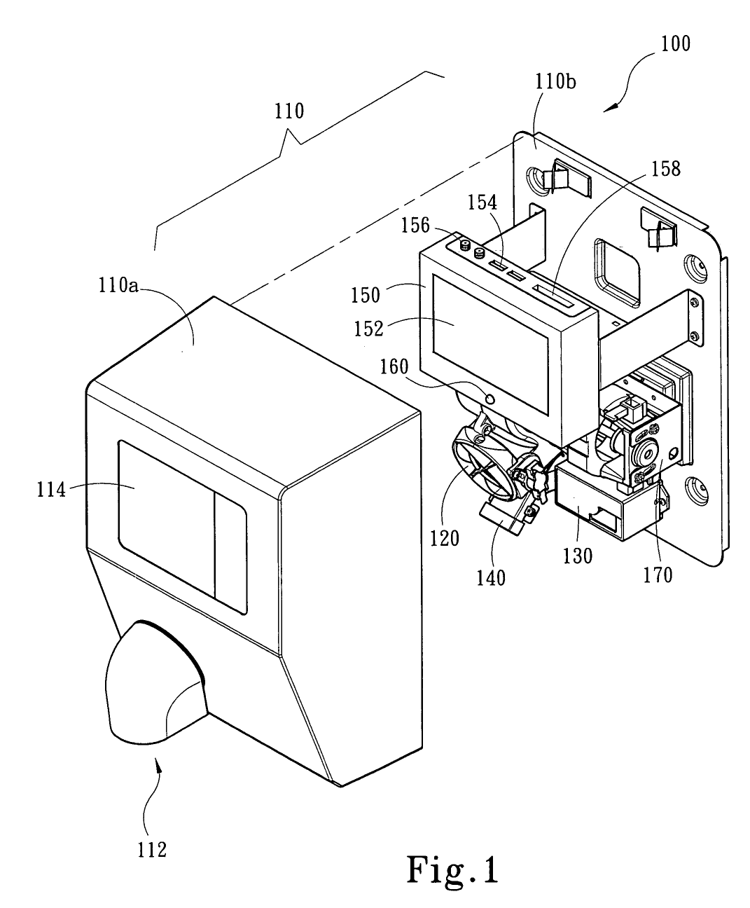

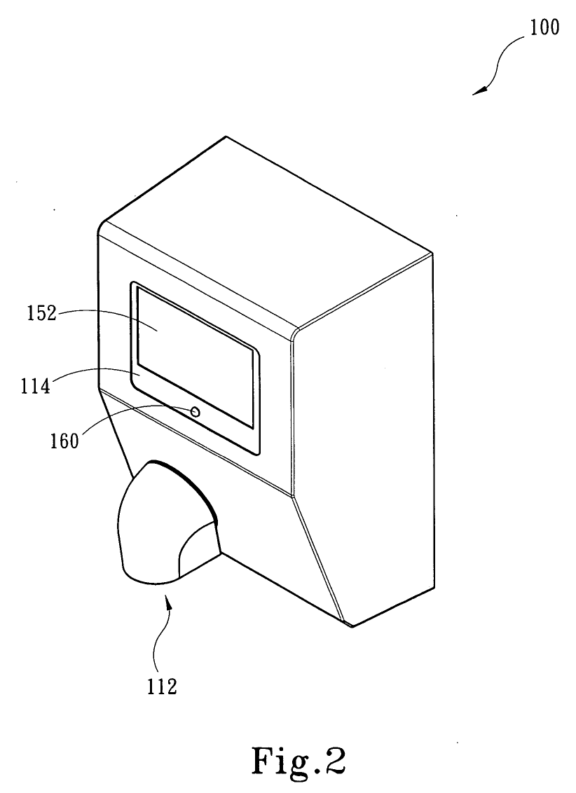

Please refer to FIGS. 1 and 2 for a first embodiment of the invention. The hand dryer equipped with video and audio playing functions 100 according to the invention mainly includes a case 110, a blower 120, a control circuit board 130, a first sensor 140, a video and audio displaying device 150 and a second sensor 160.

The case 110 includes a main case 110a and a base seat 110b that are coupled together. The blower 120, control circuit board 130, first sensor 140, and video and audio displaying device 150 are mounted onto the base seat 110b and housed in the case 110. The blower 120 and the first sensor 140 are corresponding to an air outlet 112 located on the main case 110a, and are exposed outside the case 110 through the air outlet 112. The control circuit board 130 is electrically connected to the blower 120 and the first sensor 140. The first sensor 140 may be an infrared sensor to detect user's hands when they move close to the air outlet 112 and send a first signal to the control circuit board 130. The control circuit board 130 actuates the blower 120 to dry user's hands. To those skilled in the art, the case 110 may include an electric heater 170 which is electrically connected to the control circuit board 130, and be controlled by the control circuit board 130 to enable the blower 120 to generate a more comfortable heated airflow.

The video and audio display device 150 is located on the base seat 110b and housed in the case 110. It has a display area 152 which is exposed outside the case 110 through a window 114 formed on the main case 110a. In this embodiment, the second sensor 160 such as an infrared sensor is electrically connected to the control circuit board (not shown in the drawings) of the video and audio display device 150. When a user is using the hand dryer 100 or passing by the hand dryer 100, the second sensor 160 provides a second signal to the video and audio displaying device 150 to broadcast dynamic video and audio data. As the video and audio displaying device 150 can provide dynamic video and audio data (such as MPEG images files or MP3 music files, or the like), it can further provide dynamic instant information (such as timetables, and the like) or other service contents (such as promotional films, product advertisements, and the like) that are more appealing and can motivate users to see.

Referring to FIG. 1, in the first embodiment, the video and audio displaying device 150 may further include an AV In/Out connection port 156 to connect to an external monitor (not shown in the drawing). The monitor may be located in a control room to synchronously broadcast same type of video and audio information as the video and audio displaying device 150 does to enable the monitoring function to be performed. In addition, the video and audio displaying device 150 may also include a memory slot 158 to receive a memory card (not shown in the drawings) such as a CF or MD card to update the video and audio data. Hence the video and audio displaying device 150 may be formed as a built-in memory or an external memory card.

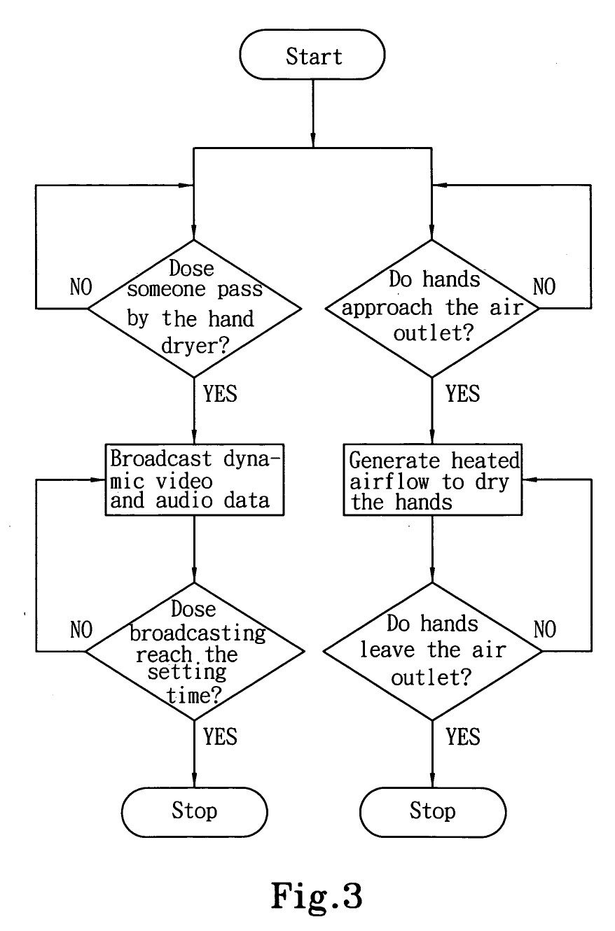

Refer to FIG. 3 for the operation flow chart of the first embodiment of the invention. The operation of the hand dryer and the dynamic video and audio broadcasting operation may be proceeded independently or concurrently. First, a power supply (such as AC 220V) provides electric power required by the hand dryer and the video and audio displaying device. When the first sensor detects a user's hands (i.e. close to the air outlet), the blower and electric heater are activated to generate heated airflow to dry user's hands. When user's hands leave, the heated airflow stops. When a user is using the hand dryer or merely passes by the hand dryer, the second sensor on the video and audio displaying device detects and activates the video and audio displaying device to broadcast dynamic video and audio data. The video and audio displaying device can stop broadcasting according to a set time, or continuously broadcast all day long according to requirements.

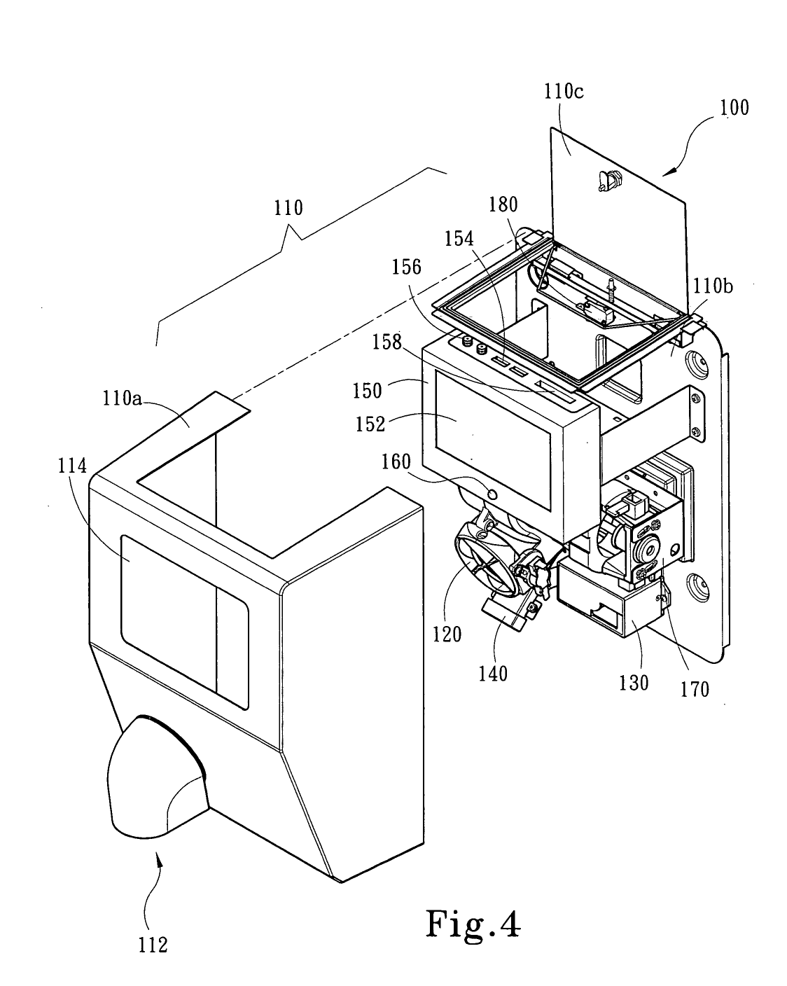

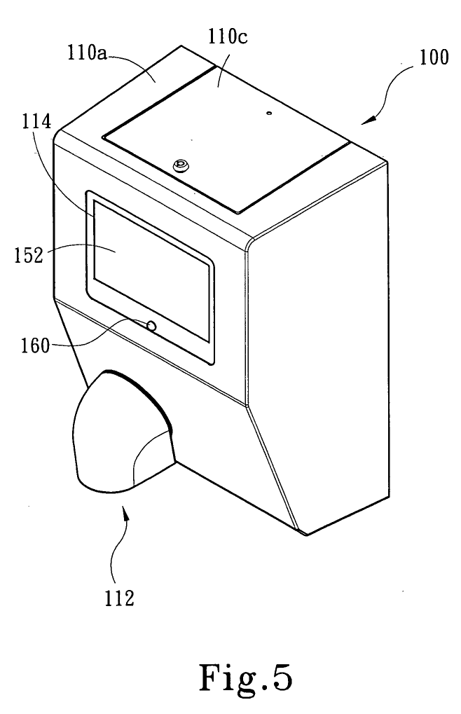

Refer to FIGS. 4 and 5 for a second embodiment of the invention. It is substantially constructed like the first embodiment previously discussed, and is marked by same numerals for the same elements. Details are omitted. The difference is that the base seat 110b has a hatch lid 110c which may be lifted and opened from the base seat 110b. Therefore the memory card slot 158 on the video and audio displaying device 150 may be exposed without removing the main case 110a to make replacing of the memory card easier. Moreover, the case 110 may further include a limit switch 180. When the hatch lid 110c covers the main case 110a, it depresses the limit switch 180 to set continuous power supply. When the hatch lid 110c is lifted from the case 110, it is separated from the limit switch 180, and the power supply is cut off to prevent electric shock so that replacing of the memory card is safer.

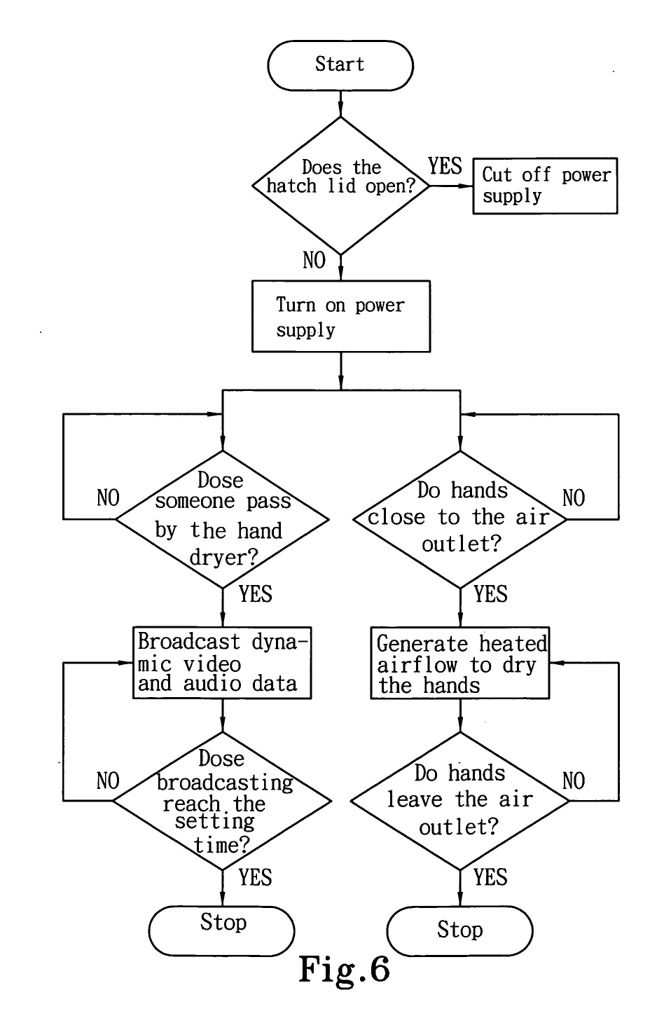

Refer to FIG. 6 for the operation flow of the second embodiment. It is largely like that of the first embodiment, thus details are omitted. The difference is that an extra step of determining whether the hatch lid is lifted is included to turn on or cut off power supply.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A hand dryer equipped with video and audio playing functions, comprising:
a case which has an air outlet;
a blower located in the case corresponding to the air outlet;
a control circuit board which is located in the case and electrically connected to the blower;
a first sensor which is exposed outside the case through the air outlet and electrically connected to the control circuit board to provide a first signal to the control circuit board to actuate the blower;
a video and audio displaying device located in the case having a display area exposed outside the case; and
a second sensor which is exposed outside the case and electrically connected to the video and audio displaying device to provide a second signal to the video and audio displaying device to broadcast dynamic video and audio data.

2. The hand dryer equipped with video and audio playing functions of claim 1, wherein the video and audio displaying device further has an AV In/Out connection port to connect to an external monitor.

3. The hand dryer equipped with video and audio playing functions of claim 1, wherein the video and audio displaying device further has a memory card slot to receive a memory card.

4. The hand dryer equipped with video and audio playing functions of claim 3, wherein the case further has a hatch lid openable from the case to expose the memory card slot to facilitate replacing of the memory card.

5. The hand dryer equipped with video and audio playing functions of claim 4, wherein the case further has a limit switch depressed by the hatch lid when closed over the case to set a power supply to continuously supply electric power, and to automatically cut off the power supply when the hatch lid is lifted from the case and separated to enhance safety of replacing of the memory card.

6. The hand dryer equipped with video and audio playing functions of claim 1, wherein the case has a window to expose the display area of the video and audio displaying device.

7. The hand dryer equipped with video and audio playing functions of claim 6, wherein the second sensor is located on the video and audio displaying device and exposed outside the case through the window.

8. The hand dryer equipped with video and audio playing functions of claim 1 further including an electric heater which is located in the case and electrically connected to the control circuit board to allow the blower to generate heated airflow.

9. The hand dryer equipped with video and audio playing functions of claim 1, wherein the video and audio displaying device broadcasts the dynamic video and audio data according to a set time.
